(19) United States
(12) Patent Application Publication
(10) Pub. No.: US 2025/0233718 A1
(43) Pub. Date: Jul. 17, 2025

(54) COMMUNICATION DEVICE AND COMMUNICATION METHOD

(71) Applicant: SONY GROUP CORPORATION, TOKYO (JP)

(72) Inventors: YUSUKE TANAKA, TOKYO (JP); KOSUKE AIO, TOKYO (JP)

(21) Appl. No.: 18/703,750

(22) PCT Filed: Oct. 21, 2022
(86) PCT No.: PCT/JP2022/039358

§ 371 Date: Apr. 23, 2024

(30) Foreign Application Priority Data
Nov. 1, 2021 (JP) 2021-178492

(51) Int. Cl. H04L 5/00; H04B 1/401

(52) U.S. Cl. CPC H04L 5/0098; H04B 1/401

(57) ABSTRACT

The present disclosure relates to a communication device and a communication method capable of more appropriately changing an operation state.

Provided is a communication device including a communication unit having at least a part of a configuration performing wireless communication using two or more frequency bands, and a control unit configured to perform control to switch the configuration between a first state in which the wireless communication is performed using the two or more frequency bands and a second state in which full-duplex wireless communication is performed using the one or more frequency bands. The present disclosure can be applied to, for example, a communication device configuring a wireless LAN system.

### TECHNICAL FIELD

The present disclosure relates to a communication device and a communication method, and more particularly, to a communication device and a communication method capable of more appropriately changing an operation state.

### BACKGROUND ART

As a method for coping with a high transmission speed or a delay request such as XR (Extended Reality), there is multi-link operation (MLO) which is wireless communication using a plurality of links. However, there is a possibility that the MLO operation cannot be performed because a communication environment of a certain link is congested or communication is not permitted in a certain link due to a legal restriction. In this case, it is assumed that the operation state is changed to the operation of communication using a single link instead of the MLO operation.

On the other hand, as a method of doubling the frequency utilization efficiency in a single link or responding to transmission in parallel, there is Full Duplex (FD) which is wireless communication that performs bidirectional communication in the same frequency band. In an FD operation, in order to remove its own transmission signal leaking to a reception side, in addition to mounting self-interference canceller (SIC) in a PHY or an RF circuit, it is assumed that transmission/reception antennas are prepared and physically separated to suppress interference.

Patent Document 1 discloses a technique for realizing an FD operation by using a hybrid coupler and a variable impedance and sharing a single antenna for transmission and reception.

### CITATION LIST

### Patent Document

Patent Document 1: Japanese Patent Application Laid-Open No. 2017-225105

### SUMMARY OF THE INVENTION

### Problems to be Solved by the Invention

When a device supporting the MLO operation changes the state to single link communication, it is assumed that communication resources that can be actually used are greatly limited with respect to a communication function originally provided in the device. In addition, an RF circuit or an antenna supporting a link that is mounted on the device but is not used may not be used and may be wasted.

On the other hand, a device supporting the FD operation needs to be equipped with antennas for transmission and reception, respectively, and is assumed to affect the device size. In this type of device, assuming that the device normally supports multiple input and multiple output (MIMO), the number of antennas to be mounted greatly increases.

In the technique disclosed in Patent Document 1, additional elements of a hybrid coupler and a variable impedance are required, and in particular, the hybrid coupler requires a size of a wavelength order, which leads to a size restriction of a mounting device. Furthermore, in the technology disclosed in Patent Document 1, combined use with an MLO operation is not considered, and if the technology is applied as it is, a hybrid coupler and a variable impedance are required for each link, a certain link cannot be used, and in a case of shifting an operation state from the MLO operation to the FD operation, a state in which the element is not used in addition to the antenna occurs.

The present disclosure has been made in view of such a situation, and an object thereof is to more appropriately change an operation state.

### Solutions to Problems

A communication device according to one aspect of the present disclosure is a communication device including: a communication unit having at least a part of a configuration performing wireless communication using two or more frequency bands, and a control unit configured to perform control to switch the configuration between a first state in which the wireless communication is performed using the two or more frequency bands and a second state in which full-duplex wireless communication is performed using the one or more frequency bands.

A communication method according to one aspect of the present disclosure is a communication method including: by a communication device including a communication unit having at least a part of a configuration performing wireless communication using two or more frequency bands, performing control to switch the configuration between a first state in which the wireless communication is performed using the two or more frequency bands and a second state in which full-duplex wireless communication is performed using the one or more frequency bands.

In the communication device and the communication method according to one aspect of the present disclosure, a configuration for performing wireless communication using two or more frequency bands is switched between a first state for performing wireless communication using two or more frequency bands and a second state for performing full-duplex wireless communication using one or more frequency bands.

A communication device according to one aspect of the present disclosure is a communication device including: a control unit configured to perform control to transmit a request for switching between a first state in which wireless communication is performed using two or more frequency bands and a second state in which full-duplex wireless communication is performed using one or more frequency bands to another communication device connected by wireless communication, in which the communication device is configured as a subordinate terminal of the another communication device.

A communication method according to one aspect of the present disclosure is a communication method including: by a communication device configured as a subordinate terminal of another communication device connected by wireless communication, performing control to transmit, to the another communication device, a request for switching between a first state in which wireless communication is performed using two or more frequency bands and a second state in which full-duplex wireless communication is performed using one or more frequency bands.

In the communication device and the communication method according to one aspect of the present disclosure, a request for switching between a first state in which wireless communication is performed using two or more frequency bands and a second state in which full-duplex wireless communication is performed using one or more frequency bands is transmitted to another communication device connected by wireless communication.

Note that the communication device according to one aspect of the present disclosure may be an independent device or an internal block configuring one device.

### BRIEF DESCRIPTION OF DRAWINGS

FIG. 1 is a diagram illustrating a configuration example of a network system according to the present disclosure.

FIG. 2 is a block diagram illustrating a configuration example of a communication device according to the present disclosure.

FIG. 3 is a block diagram illustrating a simple configuration of a two-link MLO compatible communication device.

FIG. 4 is a block diagram illustrating a simple configuration of an MLO operation state of the two-link MLO compatible communication device.

FIG. 5 is a block diagram illustrating a simple configuration of an FD operation state of the two-link MLO compatible communication device.

FIG. 6 is a block diagram illustrating a simple configuration of a three-link MLO compatible communication device.

FIG. 7 is a block diagram illustrating a simple configuration of an MLO operation state of the three-link MLO compatible communication device.

FIG. 8 is a block diagram illustrating a simple configuration of an FD operation state of the three-link MLO compatible communication device.

FIG. 9 is a sequence diagram of initial setting of an operation state.

FIG. 10 is a sequence diagram when an operation state is statically changed.

FIG. 11 is a sequence diagram when an operation state is dynamically changed.

FIG. 12 is a flowchart illustrating a flow of processing executed by a communication device according to the present disclosure.

FIG. 13 is a flowchart illustrating a flow of processing executed by a communication device according to the present disclosure.

FIG. 14 is a diagram illustrating an example of a frame format used when giving notice of an operation state and a state change function support.

FIG. 15 is a diagram illustrating an example of a frame format used when an operation state change request and a response are made.

FIG. 16 is a diagram illustrating an example of a frame format for giving notice of a current operation state or a change destination operation state.

### MODE FOR CARRYING OUT THE INVENTION

### <System Configuration Example>

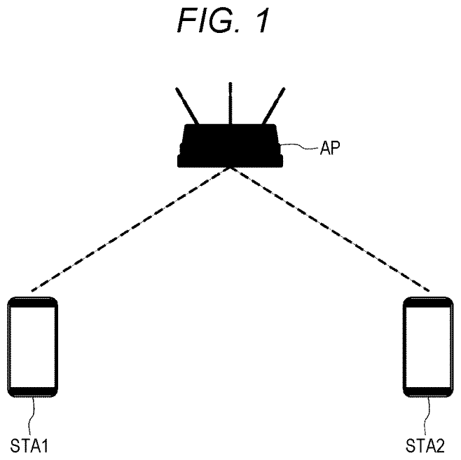

FIG. 1 is a diagram illustrating a configuration example of a network system according to the present disclosure.

In FIG. 1, the network system includes an access point (AP) that is a wireless communication device corresponding to a base station, and an STA1 and an STA2 as stations (STA) that are wireless communication devices corresponding to terminals.

The STA1 and the STA2 are connected to the AP. The AP has functions described in the present disclosure, and can perform an MLO operation, an FD operation, and switching between these operation states. The STA1 and the STA2 have functions supporting at least one of an MLO operation, an FD operation, and a single link communication operation.

The MLO operation state is a state in which an operation is performed by multi-link operation (MLO) which is wireless communication using two or more frequency bands (a plurality of links). The FD operation state is a state in which operation is performed by full duplex (FD) which is full-duplex wireless communication using one or more frequency bands.

Note that, in FIG. 1, two STAs of the STA 1 and the STA 2 are illustrated, but the number of STAs is not limited thereto.

### <Device Configuration Example>

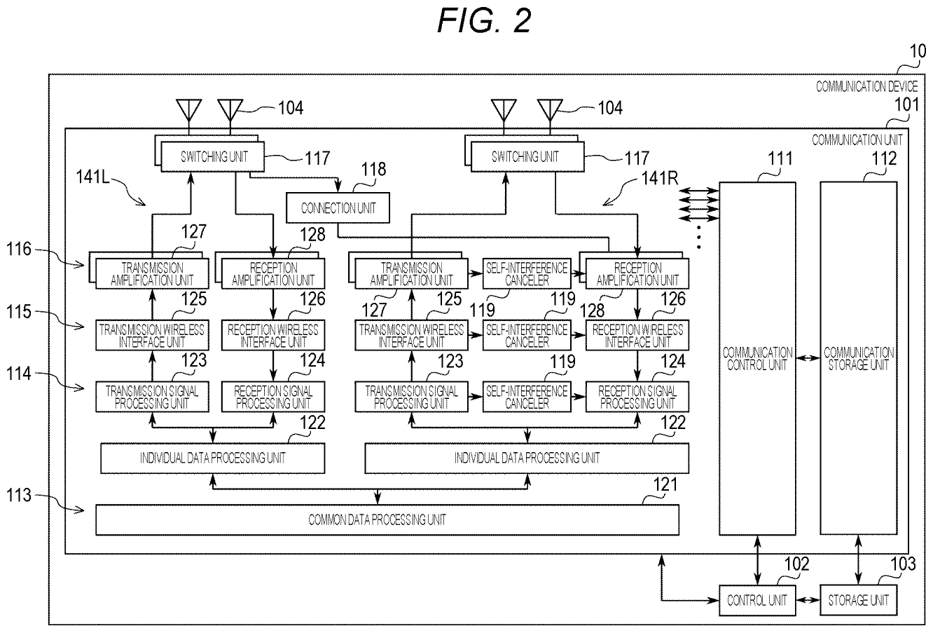

FIG. 2 is a block diagram illustrating a configuration example of a communication device (wireless communication device) according to the present disclosure.

The AP of FIG. 1 adopts a configuration illustrated in FIG. 2. The STA1 and the STA2 in FIG. 1 can adopt the configuration illustrated in FIG. 2, but may adopt a configuration of a general communication device (configuration other than the configuration illustrated in FIG. 2).

In FIG. 2, the communication device 10 mainly includes a communication unit 101, a control unit 102, a storage unit 103, and antennas 104. The communication unit 101 includes a communication control unit 111, a communication storage unit 112, a data processing unit 113, a signal processing unit 114, a wireless interface unit 115, an amplification unit 116, switching units 117, a connection unit 118, and self-interference cancellers 119.

The communication device 10 includes a left block 141L and a right block 141R supporting a predetermined frequency band (one certain frequency band) as blocks including the data processing unit 113 to the self-interference canceller 119, and the antenna 104. Here, a group of blocks on the left side in the drawing, that is, a series of units on the left side (a side not including the self-interference cancellers 119) from the individual data processing unit 122 to the antenna 104 is referred to as a left block 141L. Furthermore, a group of blocks on the right side in the drawing, that is, a series of units on the right side (a side including the self-interference cancellers 119) from the individual data processing unit 122 to the antenna 104 is referred to as a right block 141R.

The communication control unit 111 controls an operation of each unit and information transmission between the units. The communication control unit 111 also performs control to transfer control information and management information to be notified other communication devices of to each data processing unit 113.

In particular, in the present disclosure, the communication control unit 111 controls the switching units 117, the connection unit 118, the self-interference cancellers 119, and each unit so as to switch between the MLO operation state and the FD operation state.

In the MLO operation state, the communication control unit 111 disables the connection unit 118 and the self-interference cancellers 119, and performs control such that the left block 141L and the right block 141R perform communication operations in different frequency bands. Furthermore, in the FD operation state, the communication control unit 111 enables the connection unit 118 and the self-interference cancellers 119, disables the amplification unit 116 to the individual data processing unit 122 of the left block 141L, and performs control to simultaneously perform transmission and reception in the same frequency band using the right block 141R, the left and right antennas 104, and the switching unit 117. Furthermore, the communication control unit 111 controls each unit to transmit a signal using a sequence and a frame format to be described later.

The communication storage unit 112 holds information used by the communication control unit 111. Furthermore, the communication storage unit 112 holds data to be transmitted and received data.

At the time of transmission, the data processing unit 113 performs sequence management of data held in the communication storage unit 112 and control information and management information received from the communication control unit 111, performs an encryption process or the like to generate a data unit, and performs a channel access operation based on carrier sensing, addition of a media access control (MAC) header and addition of an error detection code to data to be transmitted, and a plurality of concatenation processes of the data unit. At the time of reception, the data processing unit 113 performs decoupling processing, analysis and error detection of the MAC header of the received data unit, a retransmission request operation, and decoding processing and reorder processing of the data unit.

The data processing unit 113 can include individual data processing units 122 that perform an operation necessary for communication in a single frequency band, and a common data processing unit 121 that is connected to the plurality of individual data processing units 122 and performs an operation common to communication in a plurality of frequency bands.

The signal processing unit 114 includes transmission signal processing units 123 and reception signal processing units 124. The transmission signal processing unit 123 performs encoding, interleaving, modulation, and the like on the data unit, adds a physical header, and generates a symbol stream. The reception signal processing unit 124 analyzes a physical header, performs demodulation, deinterleaving, decoding, and the like on the symbol stream, and generates a data unit. Furthermore, the reception signal processing unit 124 performs complex channel characteristic estimation and spatial separation processing as necessary.

The wireless interface unit 115 includes transmission wireless interface units 125 and reception wireless interface units 126. The transmission wireless interface unit 125 performs digital-analog signal conversion, filtering, up-conversion, and phase control on the symbol stream to generate a transmission signal. The reception wireless interface unit 126 performs down-conversion, filtering, and analog-digital signal conversion on the reception signal to generate a symbol stream.

The amplification unit 116 includes transmission amplification units 127 and reception amplification units 128. The transmission amplification unit 127 amplifies a signal input from the transmission wireless interface unit 125. The reception amplification unit 128 amplifies the signals input from the antenna 104 and the switching unit 117. A part of the amplification unit 116 may be a component outside the communication unit 101. Further, a part of the amplification unit 116 may be included in the wireless interface unit 115.

The self-interference canceller 119 is provided at least one of between the transmission amplification unit 127 and the reception amplification unit 128, between the transmission wireless interface unit 125 and the reception wireless interface unit 126, and between the transmission signal processing unit 123 and the reception signal processing unit 124 in the right block 141R. The self-interference canceller 119 operates to subtract self-interference in each unit on the reception side on the basis of the transmission signal of each unit on the transmission side. Although not illustrated, the self-interference canceller 119 may be included in the left block 141L.

The switching unit 117 switches and connects the antenna 104 and the transmission amplification unit 127 or the reception amplification unit 128 in a time division manner during the operation in the MLO operation state. In addition, during the operation in the FD operation state, the switching unit 117 connects the antenna 104 and the connection unit 118 in the left block 141L, and connects the antenna 104 and one of the transmission amplification unit 127 and the reception amplification unit 128 in the right block 141R.

The connection unit 118 is connected to the switching unit 117 of the left block 141L and one of the transmission amplification unit 127 or the reception amplification unit 128 of the right block 141R at the time of operation in the FD operation state.

The connection unit 118 may include a mechanism that suppresses leakage from the left block 141L to the right block 141R in the MLO operation state. The mechanism may be, for example, a switch or an attenuator. Further, the connection unit 118 may be connected to one of the reception amplification unit 128 or the transmission amplification unit 127 of the left block 141L and one of the transmission wireless interface unit 125 and the reception wireless interface unit 126 of the right block 141R, or one of the transmission wireless interface unit 125 and the reception wireless interface unit 126 of the left block 141L and one of the transmission signal processing unit 123 and the reception signal processing unit 124 of the right block 141R.

The control unit 102 includes a processor such as a central processing unit (CPU) or the like, for example, and controls the communication unit 101 and the communication control unit 111. The control unit 102 may perform some operations of the communication control unit 111 instead. The control unit 102 and the communication control unit 111 may be configured as one block.

The storage unit 103 includes, for example, a semiconductor memory or the like, and holds information used by the communication unit 101 and the control unit 102. The storage unit 103 may perform a part of the operation of the communication storage unit 112 instead. The storage unit 103 and the communication storage unit 112 may be configured as one block.

In each of the left block 141L and the right block 141R, the wireless interface unit 115, the amplification unit 116, the switching unit 117, and the antenna 104 may be one set, and two or more sets may be components of the communication device 10. The data processing unit 113 and the signal processing unit 114 may form one set, and two or more sets may be connected to one wireless interface unit 115.

The communication unit 101 can be realized by one or more large scale integration (LSI). Note that the configuration of the communication unit 101 is an example, and is not limited to the configuration illustrated in FIG. 2. The communication unit 101 is not limited to the two blocks of the left block 141L and the right block 141R, and may include, for example, three or more blocks. In a case of including three or more blocks, some of the blocks may share the same antenna through a frequency division unit.

The communication device 10 configured as described above has a configuration capable of changing the states of the MLO operation state and the FD operation state. In this configuration, an RF block supporting a certain frequency band (link) has a connection with an antenna and an RF SW supporting another frequency band (link) in addition to an antenna and an RF SW supporting an original frequency band (link). In addition, the configuration includes an SIC block only in a block supporting a certain frequency band (link).

Then, during the operation in the MLO operation state, the communication device 10 disables the connection and the SIC block, and realizes the MLO operation by operating each block supporting each frequency band (link). Furthermore, the communication device 10 enables the connection and the SIC block at the time of operation in the FD operation state, allocates an antenna and an RF SW supporting an original frequency band (link) and an antenna and an RF SW supporting a frequency band (link) that is not used for transmission and reception, respectively, and realizes the FD operation.

### <Example of Switching Operation State>

Hereinafter, an example in which the communication device 10 having the following two configurations (a) and (b) switches between the MLO operation and the FD operation will be described.

(a) A communication device 10 (hereinafter, also referred to as a two-link MLO compatible communication device) having a configuration capable of performing an MLO operation in two frequency bands (links).

(b) A communication device 10 (hereinafter, also referred to as a three-link MLO compatible communication device) having a configuration capable of performing an MLO operation in three frequency bands (links).

### (a) Two-Link MLO Compatible Communication Device

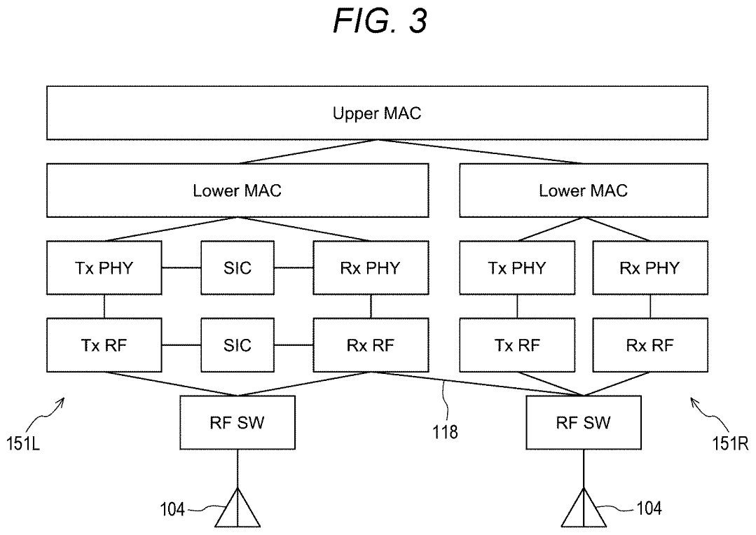

FIG. 3 is a block diagram illustrating a simple configuration of the two-link MLO compatible communication device.

In FIG. 3, each block corresponds to each block of the communication device 10 in FIG. 2. An upper MAC corresponds to the common data processing unit 121, and a lower MAC corresponds to the individual data processing unit 122. A Tx PHY and an Rx PHY correspond to the transmission signal processing unit 123 and the reception signal processing unit 124, respectively. A Tx RF corresponds to the transmission wireless interface unit 125 and the transmission amplification unit 127. An Rx RF corresponds to the reception wireless interface unit 126 and the reception amplification unit 128. A self-interference canceller (SIC) corresponds to the self-interference canceller 119. An RF SW corresponds to the switching unit 117.

For convenience of description, in the two-link MLO compatible communication device, a block group from the lower MAC to the RF SW on the side including the SIC is referred to as a left block 151L, and a block group from the lower MAC to the RF SW on the side not including the SIC is referred to as a right block 151R. The connection from the Rx RF of the left block 151L to the RF SW of the right block 151R corresponds to the connection unit 118.

The data processing unit 113 (particularly, the individual data processing unit 122) including the common data processing unit 121 corresponding to the upper MAC and the individual data processing unit 122 corresponding to the lower MAC is also referred to as a MAC unit. The signal processing unit 114 including the transmission signal processing unit 123 corresponding to the Tx PHY and the reception signal processing unit 124 corresponding to the Rx PHY is also referred to as a PHY unit. The wireless interface unit 115 including the transmission wireless interface unit 125 corresponding to the Tx RF and the reception wireless interface unit 126 corresponding to the Rx RF, and the transmission amplification unit 127 corresponding to the Tx RF and the reception amplification unit 128 corresponding to the Rx RF are also referred to as RF units. The switching unit corresponding to the RF SW is also referred to as an RF SW unit.

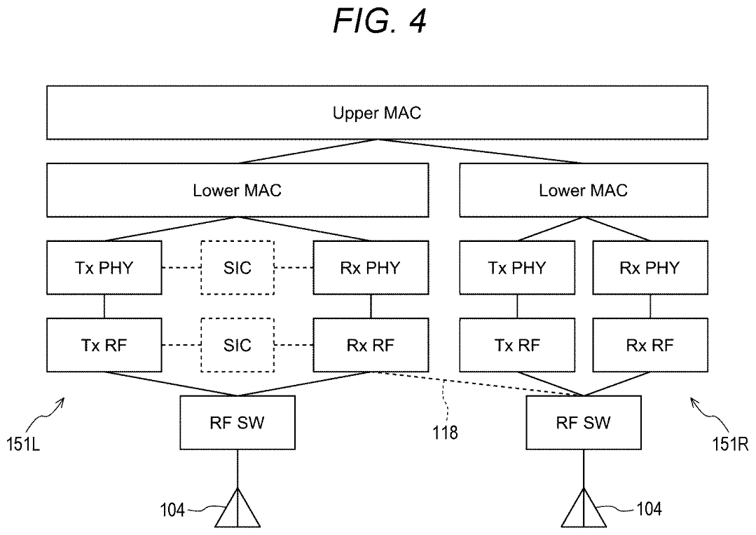

FIG. 4 is a block diagram illustrating a simple configuration of the MLO operation state of the two-link MLO compatible communication device.

In the MLO operation state, the two-link MLO compatible communication device disables the SIC of the left block 151L, and releases the connection between the Tx PHY and the Rx PHY and the connection between the Tx RF and the Rx RF through the SIC. In addition, the two-link MLO compatible communication device releases the connection between the Rx RF of the left block 151L and the RF SW of the right block 151R. In addition, the two-link MLO compatible communication device performs control such that the left block 151L and the right block 151R perform communication operations in different frequency bands. As a result, the two-link MLO compatible communication device has a configuration in which the MLO operation can be performed.

That is, the left block 151L performs transmission and reception in the first frequency band, and the right block 151R performs transmission and reception in the second frequency band. Note that, in a case where a transmission power of the right block 151R leaks into the left block 151L to cause interference due to the connection between the Rx RF of the left block 151L and the RF SW of the right block 151R released from the connection, for example, an attenuator of the connection may be operated to reduce a leaking power. Further, in order to remove the interference, an SIC may be mounted between the left block 151L and the right block 151R. Further, when the interference cannot be reduced, an operation restriction may be provided so that transmission and reception are not simultaneously performed in different frequency bands (links) in the MLO operation.

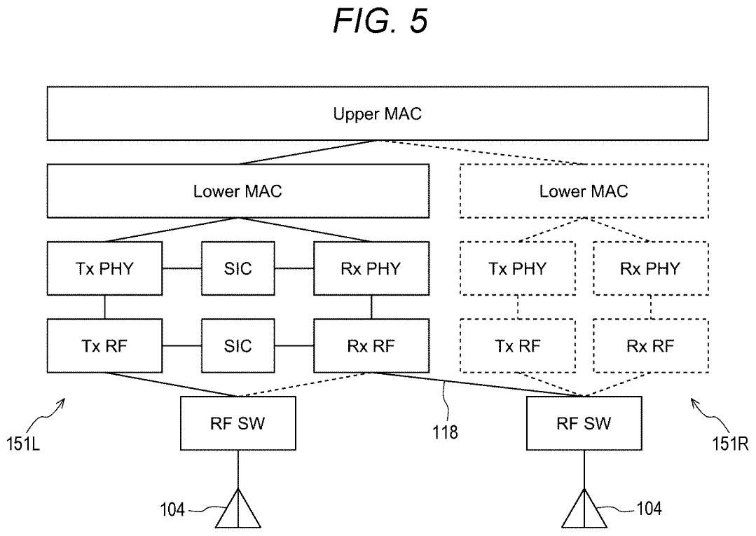

FIG. 5 is a block diagram illustrating a simple configuration of the FD operation state of the two-link MLO compatible communication device.

In the FD operation state, the two-link MLO compatible communication device enables the SIC of the left block 151L and sets the connection between the Tx PHY and the Rx PHY and the connection between the Tx RF and the Rx RF through the SIC. In addition, the two-link MLO compatible communication device releases the connection between the Rx RF and the RF SW of the left block 151L, and sets the connection between the Rx RF of the left block 151L and the RF SW of the right block 151R instead. In addition, the two-link MLO compatible communication device disables the lower MAC, the Tx PHY, the Rx PHY, the Tx RF, and the Rx RF of the right block 151R, and releases the respective connections and the connection of the upper MAC and the RF SW. In addition, the two-link MLO compatible communication device performs control such that the left block 151L and the right block 151R perform communication operations in the same frequency band. As a result, the two-link MLO compatible communication device has a configuration in which the FD operation can be performed.

That is, the left block 151L performs transmission in the first frequency band using the RF SW and the antenna 104 of the left block 151L and reception in the first frequency band (the same frequency band) using the RF SW and the antenna 104 of the right block 151R.

### (b) Three-Link MLO Compatible Communication Device

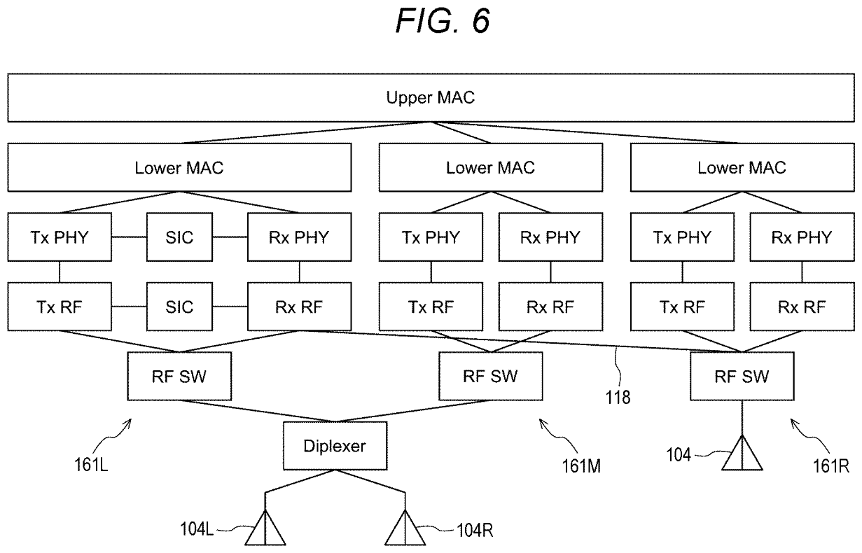

FIG. 6 is a block diagram illustrating a simple configuration of the three-link MLO compatible communication device.

In the three-link MLO compatible communication device of FIG. 6, an Upper MAC, a Lower MAC, a Tx PHY, an Rx PHY, a Tx RF, a Tx RF, an SIC, and an RF SW correspond to each block of the communication device 10 of FIG. 2, similarly to the two-link MLO compatible communication device of FIG. 3.

In FIG. 6, a Diplexer is a block having a function of connecting the plurality of antennas 104L and 104R having different operable frequencies and the RF SW by switching a frequency band.

For convenience of description, in the three-link MLO compatible communication device, a block group from the Lower MAC to the RF SW on the side including the SIC is referred to as a left block 161L, a block group from the Lower MAC to the RF SW on the side not including the SIC, which is connected to the left block 161L through the Diplexer, is referred to as a central block 161M, and a block group from the Lower MAC to the RF SW on the side not including the SIC, which is not connected to the left block 161L through the Diplexer, is referred to as a right block 161R. The connection from the Rx RF of the left block 161L to the RF SW of the right block 161R corresponds to the connection unit 118.

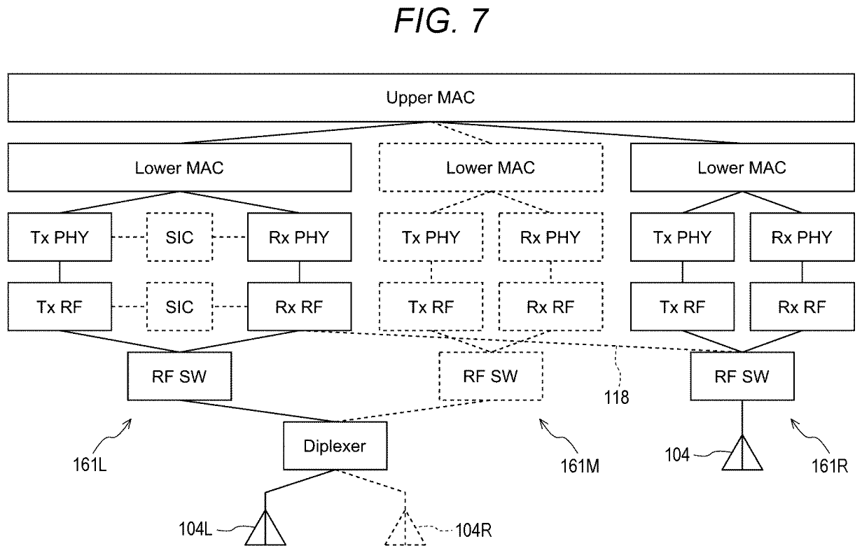

FIG. 7 is a block diagram illustrating a simple configuration of an MLO operation state of the three-link MLO compatible communication device.

In the MLO operation state, the three-link MLO compatible communication device disables the SIC of the left block 161L, and releases the connection between the Tx PHY and the Rx PHY and the connection between the Tx RF and the Rx RF through the SIC. In addition, the three-link MLO compatible communication device releases the connection between the Rx RF of the left block 161L and the RF SW of the right block 161R. In addition, the three-link MLO compatible communication device performs control such that the left block 161L and the right block 161R perform communication operations in different frequency bands.

As a result, the three-link MLO compatible communication device has a configuration in which the MLO operation can be performed.

That is, the left block 161L performs transmission and reception in the first frequency band, and the right block 161R performs transmission and reception in the second frequency band.

Furthermore, in the above description, an example has been described in which the MLO operation is performed by the left block 161L and the right block 161R, but the MLO operation may be performed by the left block 161L and the central block 161M, or by all the blocks. In this case, for example, the left block 161L is connected to the left antenna 104L, and the central block 161M is connected to the right antenna 104R, through the Diplexer.

Note that, in a case where a transmission power of the right block 161R leaks into the left block 161L to cause interference due to the connection between the Rx RF of the left block 161L and the RF SW of the right block 161R released from the connection, for example, an attenuator of the connection may be operated to reduce a leaking power. Further, in order to remove the interference, an SIC may be mounted between the left block 161L and the right block 161R. Further, when the interference cannot be reduced, an operation restriction may be provided so that transmission and reception are not simultaneously performed in different frequency bands (links) in the MLO operation.

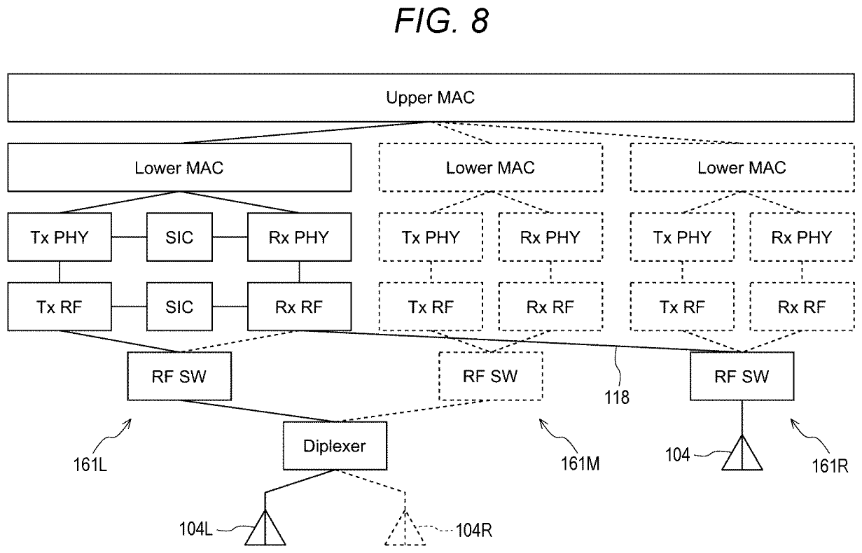

FIG. 8 is a block diagram illustrating a simple configuration of the FD operation state of the three-link MLO compatible communication device.

In the FD operation state, the three-link MLO compatible communication device enables the SIC of the left block 161L and sets the connection between the Tx PHY and the Rx PHY and the connection between the Tx RF and the Rx RF through the SIC. In addition, the three-link MLO compatible communication device releases the connection between the Rx RF and the RF SW of the left block 161L, and sets the connection between the Rx RF of the left block 161L and the RF SW of the right block 161R instead. In addition, the three-link MLO compatible communication device disables the lower MAC, the Tx PHY, the Rx PHY, the Tx RF, and the Rx RF of the right block 161R, and releases the respective connections and the connection of the upper MAC and the RF SW. In addition, the three-link MLO compatible communication device performs control such that the left block 161L and the right block 161R perform communication operations in the same frequency band. As a result, the three-link MLO compatible communication device has a configuration in which the FD operation can be performed.

That is, the left block 161L performs transmission in the first frequency band using the RF SW of the left block 161L and the antenna 104L and reception in the first frequency band (the same frequency band) using the RF SW of the right block 161R and the antenna 104. In this case, the left block 161L selects and uses the antenna 104L having the same operable frequency as the antenna 104 of the right block among the antennas 104L and 104R connected to the Diplexer.

With the above configuration of the two-link MLO compatible communication device or the three-link MLO compatible communication device, the operation state can be more appropriately changed from the MLO operation to the FD operation in a single configuration. In addition, the restriction of the communication resources can be alleviated in a situation where the MLO operation is not possible. In addition, the FD operation is enabled without mounting a dedicated antenna. In general, a configuration in which the state can be changed without increasing the number of elements connected to the transmission block whose impedance design is sensitive can be realized.

In the above description, the connection between the left block 151L (161L) and the right block 151R (161R) is Rx RF of the left block 151L (161L) and RF SW of the right block 151R (161R), but the connection location is not limited thereto. For example, the Tx RF of the left block 151L (161L) and the RF SW of the right block 151R (161R) may be connected. In this case, the RF SW and the antenna 104 used for transmission and reception at the time of the FD operation are opposite to those described above. With this configuration, a configuration in which the state can be changed can be realized without increasing the number of elements serving as noise sources connected to reception blocks that are generally sensitive to noise.

Furthermore, for example, the Rx PHY or the Tx PHY of the left block 151L (161L) and the Rx RF or the Tx RF of the right block 151R (161R) may be connected. In this case, the Rx RF or the Tx RF of the left block 151L (161L) is disabled and the Rx RF or the Tx RF of the right block 151R (161R) is enabled during the FD operation. This configuration can reduce leakage of the transmission power of the right block 151R (161R) to the left block 151L (161L) during the MLO operation.

Furthermore, for example, the connection between the left block 151L (161L) and the right block 151R (161R) may be the Rx RF of the right block 151R (161R) and the RF SW of the left block 151L (161L) in addition to the Rx RF of the left block 151L (161L) and the RF SW of the right block 151R (161R). In this case, the SIC is mounted on the left block 151L (161L) and the right block 151R (161R). This configuration makes it possible to select a block that mainly operates when the FD operation is performed, and for example, makes it possible to distribute an operation load by appropriately switching, or perform the FD operation even when one SIC cannot operate due to a failure or the like.

### <Example of Sequence>

Next, a sequence for determining an operation state in an access point multi-link device (AP MLD) supporting the function described in the present disclosure, giving notice of an operation state change from the AP MLD, and requesting an operation state change from the STA will be described. In the following description, in the AP, a subject that makes a decision is also referred to as an AP MLD (AP MLD affiliating AP), and a subject that performs communication is also referred to as an AP (AP affiliated with AP MLD). Furthermore, the STA (STA1, STA2) is also referred to as a STA (Station) or a STA (STA affiliated with non-AP MLD) belonging to non-AP MLD.

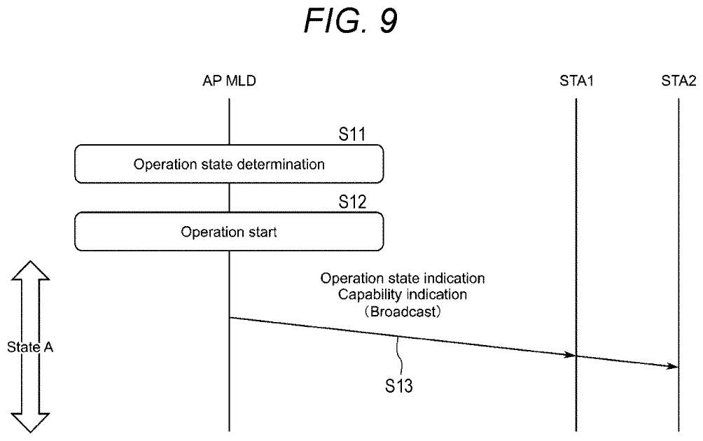

FIG. 9 is a sequence diagram when the AP MLD performs initial setting of an operation state.

The AP MLD first determines an operation state (S11). This determination is made on the basis of an observation result of the surrounding communication situation or a legal system at a place where the operation is performed. After determining the operation state, the AP MLD starts the operation in the determined operation state (state A) (S12).

Thereafter, an AP (AP affiliated with AP MLD) belonging to the AP MLD transmits a signal including information regarding the current operation state and information indicating the compatible operation state change to a broadcast destination (S13). The signal may be a management frame defined by IEEE 802.11 or a beacon frame.

Further, the signal may be included in a response signal when a signal related to a connection request is received from the STA or the STA (STA affiliated with non-AP MLD) belonging to the non-AP MLD. The signal may be a probe response frame defined by IEEE 802.11, or may be an association response frame.

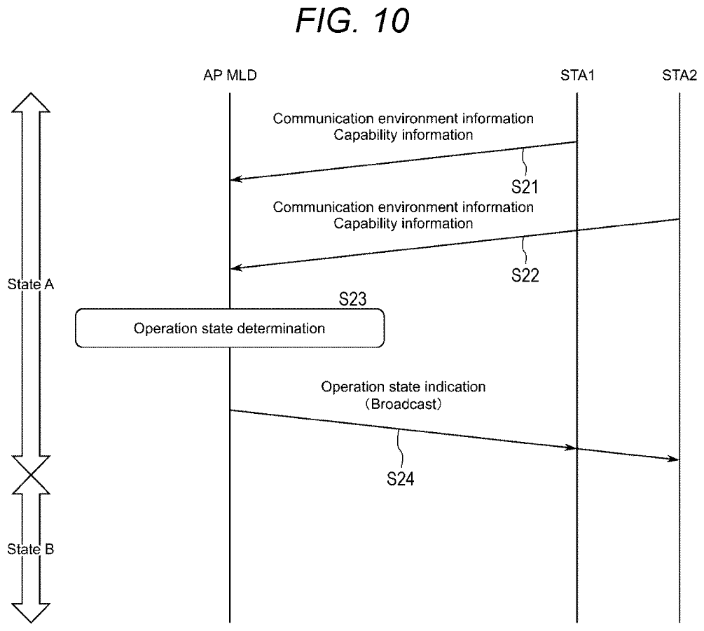

FIG. 10 is a sequence diagram when the AP MLD statically changes the operation state.

First, the AP MLD is operating in a first operation state (state A). The AP belonging to the AP MLD receives, from the STA or the STA belonging to the non-AP MLD, a signal including at least one of information regarding a communication status observed by the STA or the STA belonging to the non-AP MLD and information regarding capability that is a function of the STA or the STA belonging to the non-AP MLD (S21, S22). The signal may be included in a part of a normal data signal, or may be included in a signal related to connection. The signal related to the connection may be a probe request frame defined in IEEE 802.11 or an association request frame.

The AP MLD (AP MLD affiliating AP) to which the AP that has received the information belongs determines the operation state on the basis of the information (S23). In this example, it is assumed that AP MLD determines a change in the operation state. The AP belonging to the AP MLD that has determined the change in the operation state transmits a signal including information about a changed second operation state (state B) to a broadcast address (S24). The signal may be a management frame defined by IEEE 802.11 or a beacon frame. The information may include information regarding a timing at which the change is performed.

After transmitting the signal, the AP MLD changes the operation state from the first operation state (state A) to the second operation state (state B). For example, the first operation state is the MLO operation state and the second operation state is the FD operation state. Note that, after the change of the operation state, the AP belonging to the AP MLD may transmit information indicating that the operation state has been changed to the second operation state to the STA or the broadcast.

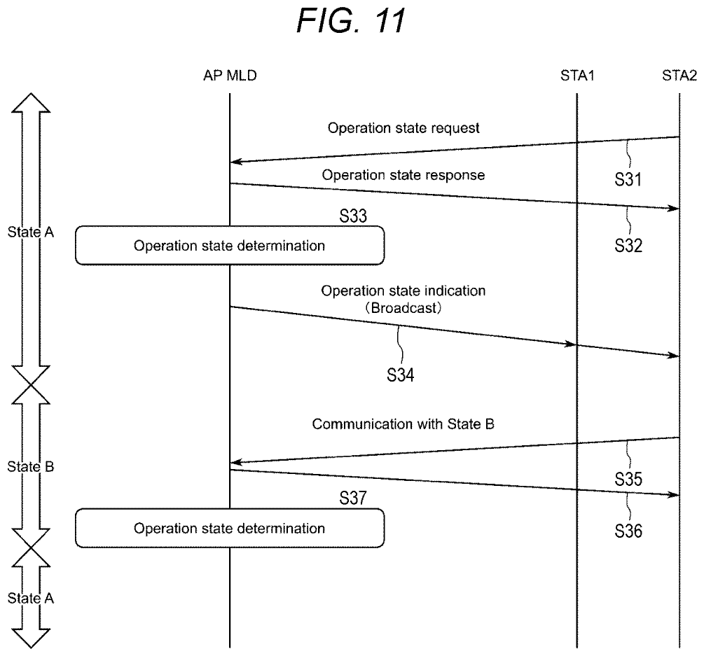

FIG. 11 is a sequence diagram when the AP MLD dynamically changes the operation state.

First, the AP MLD is operating in a first operation state (state A). The STA or the STA belonging to the non-AP MLD transmits a signal including information regarding a request for changing an operation state (a request including an operation state of a switching destination) to the AP belonging to the AP MLD (S31). For example, the STA or the STA belonging to the non-AP MLD transmits the signal in order to transition to an operation state suitable for suppressing power consumption or suitable for traffic handled by the STA itself. At this time, the AP belonging to the AP MLD may respond to the request to the STA or the STA belonging to the non-AP MLD (S32).

The AP MLD to which the AP that has received the signal from the STA or the STA belonging to the non-AP MLD belongs determines the operation state on the basis of the information included in the signal (S33). In this example, it is assumed that AP MLD determines a change in the operation state. The AP belonging to the AP MLD that has determined the change in the operation state transmits a signal including information regarding a changed second operation state (state B) to a broadcast address (S34). The signal may be a management frame defined by IEEE 802.11 or a beacon frame. The information may include information regarding a timing at which the change is made and a period during which the second operation state (state B) is continued.

After the AP belonging to the AP MLD has transmitted the signal, the AP MLD to which the AP belongs changes the operation state from the first operation state (state A) to the second operation state (state B). For example, the first operation state is the MLO operation state and the second operation state is the FD operation state. Note that, after the operation state has been changed, the AP belonging to the AP MLD may transmit information indicating that the operation state has been changed to the second operation state to the STA or the STA belonging to the non-AP MLD, or to the broadcast. As a result, the AP belonging to the AP MLD and the STA or the STA belonging to the non-AP MLD can perform communication in the second operation state (state B) (S35, S36).

The AP MLD to which the AP that has communicated with the STA or the STA belonging to the non-AP MLD in the second operation state belongs determines whether to return to the first operation state after a period in which the second operation state continues elapses (S37). After determining to return to the first operation state, the AP MLD changes the operation state from the second operation state (state B) to the first operation state (state A). For example, the second operation state is the FD operation state, and the first operation state is the MLO operation state.

Note that the AP belonging to the AP MLD may transmit the information indicating that the change is performed before the change of the operation state or the information indicating that the change is performed after the change to the STA or the STA belonging to the non-AP MLD, or to the broadcast.

### <Flow of Processing of Each Device>

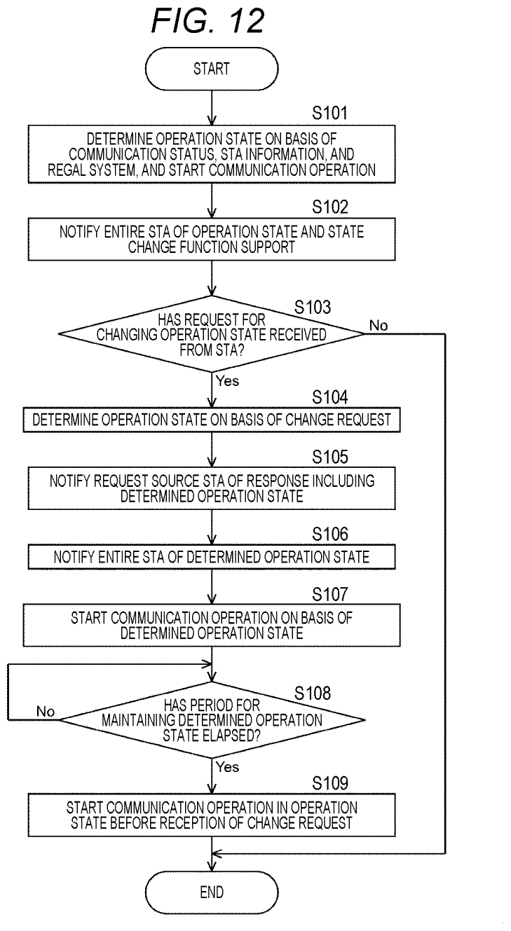

FIG. 12 is a flowchart illustrating a flow of processing executed by the communication device 10 having a function as the AP MLD or the AP belonging to the AP MLD.

In Step S101, the communication control unit 111 determines the operation state on the basis of the communication status (communication environment), the information of the STA, and the legal system, and starts the communication operation. Here, the communication control unit 111 can determine the operation state on the basis of at least one piece of information regarding the observed communication status, the response function of the subordinate STA, and the legal system of the place where the operation is performed. In Step S102, the communication control unit 111 notifies the entire STA of the operation state and the state change function support.

In Step S103, the communication control unit 111 determines whether or not a request for changing the operation state has been received from the STA or the STA belonging to the non-AP MLD. In a case where it is determined in Step S103 that the change request has been received, the processing proceeds to Step S104.

In Step S104, the communication control unit 111 determines the operation state on the basis of the received change request. In Step S105, the communication control unit 111 notifies the STA of the request source or the STA belonging to the non-AP MLD of a response including the determined operation state. Furthermore, in Step S106, the communication control unit 111 notifies the entire STA of the determined operation state.

In Step S107, the communication control unit 111 starts the communication operation on the basis of the determined operation state.

In Step S108, the communication control unit 111 determines whether or not a period for maintaining the determined operation state has elapsed. In Step S108, the processing proceeds to Step S109 after the elapse of the maintenance period.

In Step S109, the communication control unit 111 starts the communication operation in an operation state before reception of the change request.

The process of Step S109 ends, and then a series of process of changing the operation state is completed. Note that, in a case where it is determined in Step S103 that the change request has not been received, Steps S104 to S109 are skipped, and the processing ends.

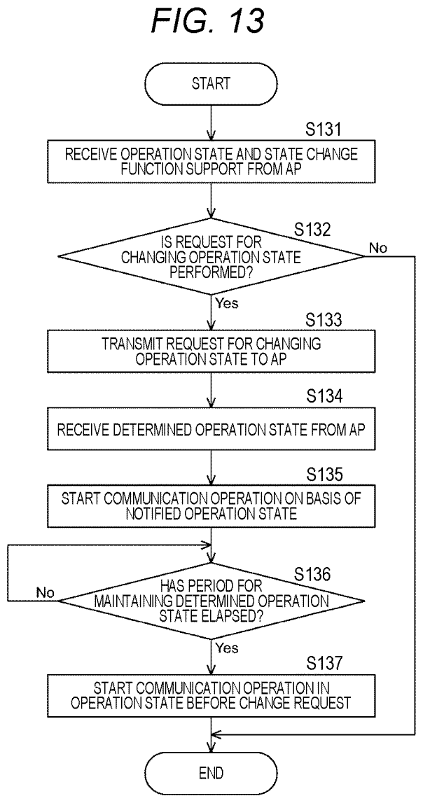

FIG. 13 is a flowchart illustrating a flow of processing executed by the communication device 10 having a function as the STA or the STA belonging to the non-AP MLD.

In FIG. 13, in order to describe a case where the STA or the STA belonging to the non-AP MLD adopts the configuration illustrated in FIG. 2, the subject of the processing is the communication control unit 111. Note that, in a case where the STA or the STA belonging to the non-AP MLD adopts the configuration of a general communication device, the subject of the processing is a communication control unit (not illustrated) included in the general communication device.

In Step S131, the communication control unit 111 receives the operation state and the state change function support from the AP belonging to the AP MLD.

In Step S132, the communication control unit 111 determines whether or not to make a request for changing the operation state. In a case where it is determined in Step S132 that the change request is to be made, the processing proceeds to Step S133.

In Step S133, the communication control unit 111 transmits a request for changing the operation state to the APs belonging to the AP MLD.

In Step S134, the communication control unit 111 receives the determined operation state from the AP belonging to the AP MLD. In Step S135, the communication control unit 111 determines its own operation state on the basis of the notified operation state and starts the communication operation.

In Step S136, the communication control unit 111 determines whether or not a period for maintaining the determined operation state has elapsed. In Step S136, the processing proceeds to Step S137 after the elapse of the maintenance period.

In Step S137, the communication control unit 111 starts the communication operation in the operation state before the change request.

The process of Step S137 ends, and then a series of process of changing the operation state is completed. Note that, in a case where it is determined in Step S132 that the change request is not to be made, Steps S133 to S137 are skipped, and the processing ends.

### <Example of Frame Format>

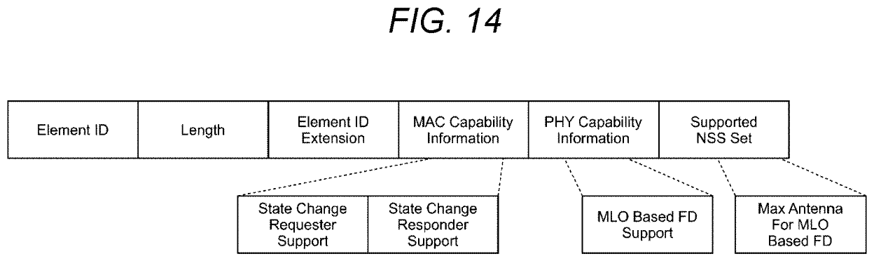

FIG. 14 is a diagram illustrating an example of a frame format used when giving notice of the operation state and the state change function support.

The Element ID and the Element ID Extension include information indicating that this frame format is a format giving notice of the operation state and the state change function support.

A Length includes information regarding a length of the frame format. A MAC Capability Information includes information regarding a capability of a MAC of the communication device that transmits the frame.

The MAC Capability Information includes a State Change Requester Support indicating a fact that the MAC supports execution of the state change request and a State Change Responder Support indicating a fact that the MAC supports a response to the state change request.

A PHY Capability Information includes information regarding the capability of a PHY of the communication device that transmits the frame. The PHY Capability Information includes an MLO Based FD Support indicating that the PHY supports the MLO operation state, the FD operation state, and a change in the operation state described in the present disclosure.

A Supported NSS Set includes information regarding the number of operable antennas or the number of spatial streams. The Supported NSS Set includes a Max Antenna For MLO Based FD indicating information regarding the number of antennas or the number of spatial streams operable when the MLO operation is performed or information regarding the number of antennas or the number of spatial streams operable when the FD operation is performed.

The frame format having the configuration described above can be used for, for example, frames transmitted in S13 of FIG. 9, S24 of FIG. 10, S34 of FIG. 11, and the like.

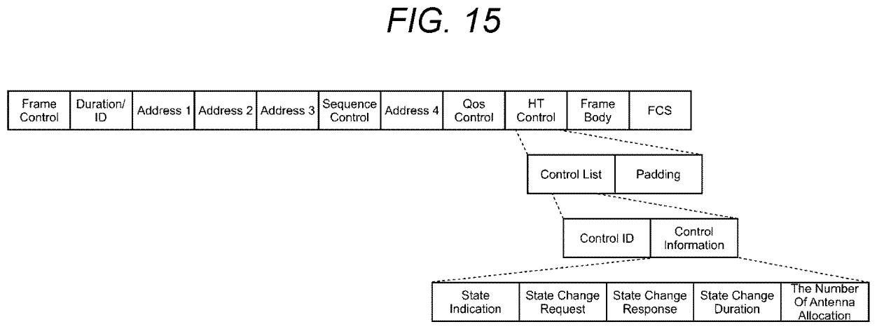

FIG. 15 is a diagram illustrating an example of a frame format used when the operation state change request and the response are made.

A Frame Control includes information regarding the type of this frame. A Duration/ID includes information regarding a length of this frame. An Address 1 includes information regarding a transmission destination address of this frame. An Address 2 includes information regarding a transmission source address of the frame. An Address 3 and an Address 4 include information regarding a transmission destination address and a transmission source address of this frame.

A Sequence Control includes information regarding data stored in a Frame Body. A QoS Control includes information regarding QoS control of data stored in the Frame Body.

An HT Control includes information regarding an operation state change request and a response. The Frame Body includes data. Note that data may be null in this frame format. An FCS includes information regarding error detection.

An HT Control may include a Control List and a Padding. The Control List may include a plurality of pieces of information regarding the request for changing the operation state and the response, and other information. The Padding includes information regarding length adjustment of the Control List.

The Control List may include a Control ID and Control Information. The Control ID includes information for identifying Control Information. The Control Information includes information regarding a request for changing the operation state and a response.

The Control Information includes a State Indication, a State Change Request, a State Change Response, a State Change Duration, and The Number Of Antenna Allocation.

The State Indication includes information regarding a current operation state. The State Indication includes, for example, information indicating the MLO operation state or information indicating the FD operation state. A State Change Request includes information regarding a request for changing the operation state. The information regarding the operation state change request may include information regarding the operation state of the change destination and information regarding a duration of the operation state of the change destination.

The State Change Response includes information regarding a response to the operation state change request. The information regarding the response to the operation state change request may include information regarding acceptance or rejection of the request, information regarding a reason for the acceptance or rejection, and information regarding the operation state of the change destination. A State Change Duration includes information regarding a duration of the operation state of the change destination.

The Number Of Antenna Allocation includes information regarding the number of antennas or the number of spatial streams operable in each link during the MLO operation or information regarding the number of antennas or the number of spatial streams operable during the FD operation.

The frame format having the configuration described above can be used, for example, for a frame to be transmitted in S32 of FIG. 11.

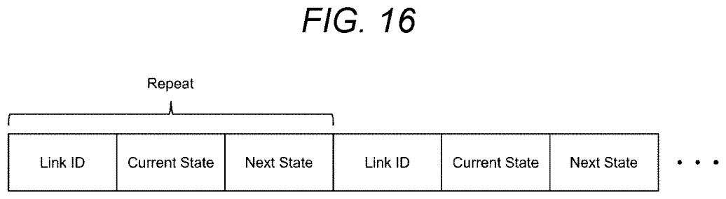

FIG. 16 is a diagram illustrating an example of a frame format for giving notice of information regarding a current operation state or a change destination operation state.

A Link ID includes information for identifying a certain link being formed. A Current State includes information regarding the current operation state of the link corresponding to the Link ID. A Next State includes information regarding the operation state after the change of the link corresponding to the Link ID.

The information regarding the operation state here is, for example, information indicating a single link operation state, an MLO operation state, or an FD operation state. In the case of the FD operation state, information indicating whether transmission or reception is performed may be included. Further, in a case where the changed operation state is the same as the current operation state, information indicating that the operation state is not changed may be included. Further, in a case where the MLO operation state is changed to the FD operation state, information indicating whether the current link formation is discarded or temporarily stopped may be included.

The frame format having the configuration described above can be used for, for example, a field that is a State Indication in the frame format of FIG. 15.

As described above, the communication device 10 has a configuration of the two-link MLO compatible communication device, the three-link MLO compatible communication device, or the like, thereby enabling more appropriate state change between the MLO operation state and the FD operation state. In this configuration, an RF block supporting a certain frequency band has a connection with an antenna and an RF SW supporting another frequency band in addition to an antenna and an RF SW supporting the original frequency band. This configuration also includes an SIC block only in a block supporting a certain frequency band.

Then, the communication device 10 disables the connection and the SIC block during the operation in the MLO operation state, and realizes the MLO operation with each block operating while supporting each link. Furthermore, the communication device 10 enables the connection and the SIC block at the time of operation in the FD operation state, allocates the antenna and the RF SW supporting the original link and the antenna and the RF SW supporting the link that is not used to transmission and reception, respectively, and realizes the FD operation state.

With such a configuration, when falling back (Fallback) from the MLO operation, the state can be shifted to the FD operation instead of the general single link operation, and the restriction of the communication resources can be relaxed. Furthermore, the FD operation can be enabled without mounting an additional antenna for the FD operation. Furthermore, the AP can appropriately switch between the MLO operation and the FD operation without mounting an additional antenna according to the capability of the STA to be connected. Frequency utilization efficiency, throughput, capacity, and communication delay can be also improved.

Note that, a series of processing of the communication device 10 described above can be executed by hardware or software. In a case where the series of processing is executed by the software, a program that forms the software is installed on the communication device 10.

Herein, in this specification, the processing performed by the computer according to the program is not necessarily required to be performed in chronological order along the order described as the flowchart. That is, the processing to be performed by the computer in accordance with the program includes processing to be executed in parallel or independently of one another (parallel processing or object-based processing, for example). Furthermore, the program may be executed by one computer (processor), or may be executed by a plurality of computers in a distributed manner. Moreover, the program may be transferred to a remote computer, and be executed therein. In the present specification, a system means a set of a plurality of components (apparatuses, modules (parts) and the like), and it does not matter whether or not all the components are in the same housing.

Embodiments of the present disclosure are not limited to the above-described embodiment, and various modifications can be made in a range without departing from the gist of the present disclosure. For example, in the above description, the exemplary embodiments have been described with reference to a sequence diagram, a flowchart, and a frame format. However, these exemplary embodiments are not necessarily limited to the illustrated configuration, and may be selectively used according to a situation. The effects described in the present specification are merely examples and are not limited, and other effects may be provided.

Note that the present disclosure can also have the following configurations.

(1)

A communication device including:
a communication unit having at least a part of a configuration performing wireless communication using two or more frequency bands; and a control unit configured to perform control to switch the configuration between a first state in which the wireless communication is performed using the two or more frequency bands and a second state in which full-duplex wireless communication is performed using the one or more frequency bands.
   (2)

The communication device according to (1) described above, in which
the configuration includes two or more blocks each including a MAC unit, a PHY unit, an RF unit, an antenna, and an RF SW unit supporting a predetermined frequency band.
   (3)

The communication device according to (2) described above, in which
the configuration includes a connection unit that connects the blocks.
   (4)

The communication device according to (2) or (3) described above, in which
the configuration includes a self-interference canceller in at least one less number of blocks than the number of blocks.
   (5)

The communication device according to (4) described above, in which
the control unit disables the connection unit and the self-interference canceller in a case of performing wireless communication in the first state.
   (6)

The communication device according to (4) or (5) described above, in which
in a case of performing wireless communication in the second state, the control unit enables the connection unit and the self-interference canceller, and disables the MAC unit, the PHY unit, and the RF unit that configure some of the blocks.
   (7)

The communication device according to any one of (2) to (6) described above, in which
the control unit determines whether to switch the operation state to the first state or the second state on a basis of predetermined information.
   (8)

The communication device according to (7) described above, in which
the control unit determines whether or not to switch the operation state on a basis of at least one piece of information of an observed communication status, a legal system of an operating place, and information regarding a subordinate terminal.
   (9)

The communication device according to (8) described above, in which
the information regarding the subordinate terminal includes at least one of a compatible function of the subordinate terminal and a switching request from the subordinate terminal.
   (10)

The communication device according to (8) or (9) described above, in which
the control unit determines whether to switch the operation state and then notifies the subordinate terminal of information regarding the determined operation state.
   (11)

The communication device according to (10) described above, in which
the control unit performs switching to the determined operation state after notifying the subordinate terminal of the information.
   (12)

The communication device according to (3) to (6) described above, in which
the MAC unit includes a data processing unit,
the PHY unit includes a transmission signal processing unit and a reception signal processing unit,
the RF unit includes a transmission wireless interface unit and a transmission amplification unit, and a reception wireless interface unit and a reception amplification unit, and
the RF SW unit includes a switching unit that switches the transmission amplification unit, the reception amplification unit, or the connection unit to connect to the antenna.
   (13)

A communication method including:
by a communication device including a communication unit having at least a part of a configuration performing wireless communication using two or more frequency bands,
performing control to switch the configuration between a first state in which the wireless communication is performed using the two or more frequency bands and a second state in which full-duplex wireless communication is performed using the one or more frequency bands.
   (14)

A communication device including:
a control unit configured to perform control to transmit a request for switching between a first state in which wireless communication is performed using two or more frequency bands and a second state in which full-duplex wireless communication is performed using one or more frequency bands to another communication device connected by wireless communication, in which
the communication device is configured as a subordinate terminal of the another communication device.
   (15)

The communication device according to (14) described above, in which
the control unit transmits information regarding a compatible function that is a function of the subordinate terminal to the another communication device.
   (16)

The communication device according to (14) or (15) described above, in which
the control unit transmits information regarding the observed communication status to the another communication device.
   (17)

The communication device according to any one of (14) to (16) described above, in which the control unit transmits the request including an operation state of a switching destination to the another communication device.

(18)

The communication device according to any one of (14) to (17) described above, in which
the control unit determines an operation state of the subordinate terminal on a basis of information regarding an operation state transmitted from the another communication device.
   (19)

A communication method including:
by a communication device configured as a subordinate terminal of another communication device connected by wireless communication,
performing control to transmit, to the another communication device, a request for switching between a first state in which wireless communication is performed using two or more frequency bands and a second state in which full-duplex wireless communication is performed using one or more frequency bands.

### REFERENCE SIGNS LIST

10 Communication device
101 Communication unit
102 Control unit
103 Storage unit
104 Antenna
111 Communication control unit
112 Communication storage unit
113 Data processing unit
114 Signal processing unit
115 Wireless interface unit
116 Amplification unit
117 Switching unit
118 Connection unit
119 Self-interference canceller
121 Common data processing unit
122 Individual data processing unit
123 Transmission signal processing unit
124 Reception signal processing unit
125 Transmission wireless interface unit
126 Reception wireless interface unit
127 Transmission amplification unit
128 Reception amplification unit
141L Left block
141R Right block
151L Left block
151R Right block
161L Left block
161M Center block
161R Right block

1. A communication device comprising:
a communication unit having at least a part of a configuration performing wireless communication using two or more frequency bands; and a control unit configured to perform control to switch the configuration between a first state in which the wireless communication is performed using the two or more frequency bands and a second state in which full-duplex wireless communication is performed using the one or more frequency bands.

2. The communication device according to claim 1, wherein
the configuration includes two or more blocks each including a MAC unit, a PHY unit, an RF unit, an antenna, and an RF SW unit supporting a predetermined frequency band.

3. The communication device according to claim 2, wherein
the configuration includes a connection unit that connects the blocks.

4. The communication device according to claim 3, wherein
the configuration includes a self-interference canceller in at least one less number of blocks than the number of blocks.

5. The communication device according to claim 4, wherein
the control unit disables the connection unit and the self-interference canceller in a case of performing wireless communication in the first state.

6. The communication device according to claim 4, wherein
in a case of performing wireless communication in the second state, the control unit enables the connection unit and the self-interference canceller, and disables the MAC unit, the PHY unit, and the RF unit that configure some of the blocks.

7. The communication device according to claim 2, wherein
the control unit determines whether to switch the operation state to the first state or the second state on a basis of predetermined information.

8. The communication device according to claim 7, wherein
the control unit determines whether or not to switch the operation state on a basis of at least one piece of information of an observed communication status, a legal system of an operating place, and information regarding a subordinate terminal.

9. The communication device according to claim 8, wherein
the information regarding the subordinate terminal includes at least one of a compatible function of the subordinate terminal and a switching request from the subordinate terminal.

10. The communication device according to claim 8, wherein
the control unit determines whether to switch the operation state and then notifies the subordinate terminal of information regarding the determined operation state.

11. The communication device according to claim 10, wherein
the control unit performs switching to the determined operation state after notifying the subordinate terminal of the information.

12. The communication device according to claim 4, wherein
the MAC unit includes a data processing unit,
the PHY unit includes a transmission signal processing unit and a reception signal processing unit,
the RF unit includes a transmission wireless interface unit and a transmission amplification unit, and a reception wireless interface unit and a reception amplification unit, and
the RF SW unit includes a switching unit that switches the transmission amplification unit, the reception amplification unit, or the connection unit to connect to the antenna.

13. A communication method comprising:
by a communication device including a communication unit having at least a part of a configuration performing wireless communication using two or more frequency bands,
performing control to switch the configuration between a first state in which the wireless communication is performed using the two or more frequency bands and a second state in which full-duplex wireless communication is performed using the one or more frequency bands.

14. A communication device comprising:
a control unit configured to perform control to transmit a request for switching between a first state in which wireless communication is performed using two or more frequency bands and a second state in which full-duplex wireless communication is performed using one or more frequency bands to another communication device connected by wireless communication, wherein
the communication device is configured as a subordinate terminal of the another communication device.

15. The communication device according to claim 14, wherein
the control unit transmits information regarding a compatible function that is a function of the subordinate terminal to the another communication device.

16. The communication device according to claim 14, wherein
the control unit transmits information regarding the observed communication status to the another communication device.

17. The communication device according to claim 14, wherein the control unit transmits the request including an operation state of a switching destination to the another communication device.

18. The communication device according to claim 14, wherein
the control unit determines an operation state of the subordinate terminal on a basis of information regarding an operation state transmitted from the another communication device.

19. A communication method comprising:
by a communication device configured as a subordinate terminal of another communication device connected by wireless communication,
performing control to transmit, to the another communication device, a request for switching between a first state in which wireless communication is performed using two or more frequency bands and a second state in which full-duplex wireless communication is performed using one or more frequency bands.
